(19) United States
(12) Patent Application Publication
(10) Pub. No.: US 2025/0208059 A1
(43) Pub. Date: Jun. 26, 2025

(54) MIRROR-BASED RELAY FOR AN OPTICAL INSPECTION SYSTEM

(71) Applicant: Applied Materials Israel Ltd., Rehovot (IL)

(72) Inventors: Boris GOLBERG, Ashdod (IL); Avishai BARTOV, Hod Hasharon (IL); David Ross SHAFER, Fairfield, CT (US); Ram ORON, Ness Ziona (IL)

(21) Appl. No.: 18/391,562

(22) Filed: Dec. 20, 2023

(51) Int. Cl. G01N 21/95

(52) U.S. Cl. CPC G01N 21/9501; G01N 2201/0636

(57) ABSTRACT

An optical inspection system for inspection of a mask or a wafer, the system including an objective for collecting light coming from an object being inspected, a relay component placed on an optical path between the objective and an imaging component, for collecting light from the objective, and relaying the collected light to the imaging component, wherein the optical inspection system further includes a mirror placed on the optical path between the objective and the relay module, for changing a direction of the optical path at an angle away from an optical axis of the objective and into an optical axis of the relay component, the relay component includes reflecting surfaces arranged such that the collected light passes back and forth within the relay component three times. Related apparatus and methods are also described.

### BACKGROUND AND TECHNOLOGICAL FIELD

The present disclosure, in some embodiments thereof, relates to a relay module for an optical inspection system and, more particularly, but not exclusively, to a mirror-based catadioptric-like relay module for an optical inspection system.

The present disclosure relates to systems and methods for detecting defects and anomalies in surfaces, in general and to systems and methods for detecting defects and anomalies in a silicon wafer and/or in masks used in the production of semiconductor devices.

In a simple bright-field based system and/or method for detecting defects and anomalies in surfaces, an illumination system illuminates a specimen from above, and a collection optical system located above or below the specimen, detects the light reflected or scattered from the specimen. The term bright-field refers herein to light thus collected.

In a typical dark-field based technique, either the specimen is illuminated from above and light reflected therefrom is collected from the sides, or the specimen is illuminated from the side and light reflected therefrom is collected from above. The terms dark-field and/or grey-field refer herein to light thus collected.

### BRIEF DESCRIPTION OF THE DRAWING(S)

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a simplified illustration of components and optical paths in a prior art optical inspection system;

FIG. 2A is a simplified illustration of components and optical paths in an example embodiment;

FIG. 2B is a simplified illustration of components and optical paths in an example embodiment;

FIG. 2C is a simplified illustration of components and optical paths in an example embodiment;

FIG. 3 is a simplified isometric illustration of components and optical paths in the example embodiment of FIG. 2A; and

FIG. 4 is a simplified illustration of components and optical paths in an example embodiment.

### DETAILED DESCRIPTION OF EXAMPLES

The present disclosure, in some embodiments thereof, relates to a relay module for an optical inspection system and, more particularly, but not exclusively, to a mirror-based catadioptric-like relay module for an optical inspection system.

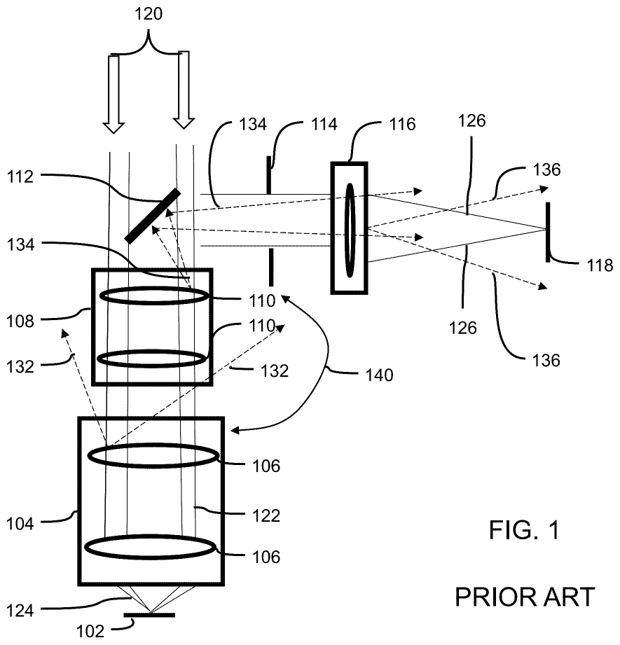

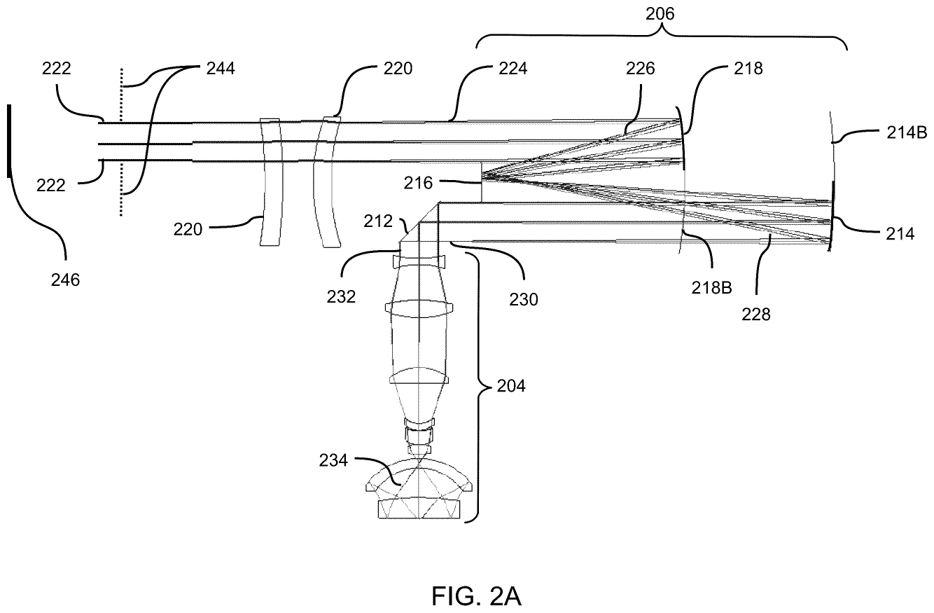

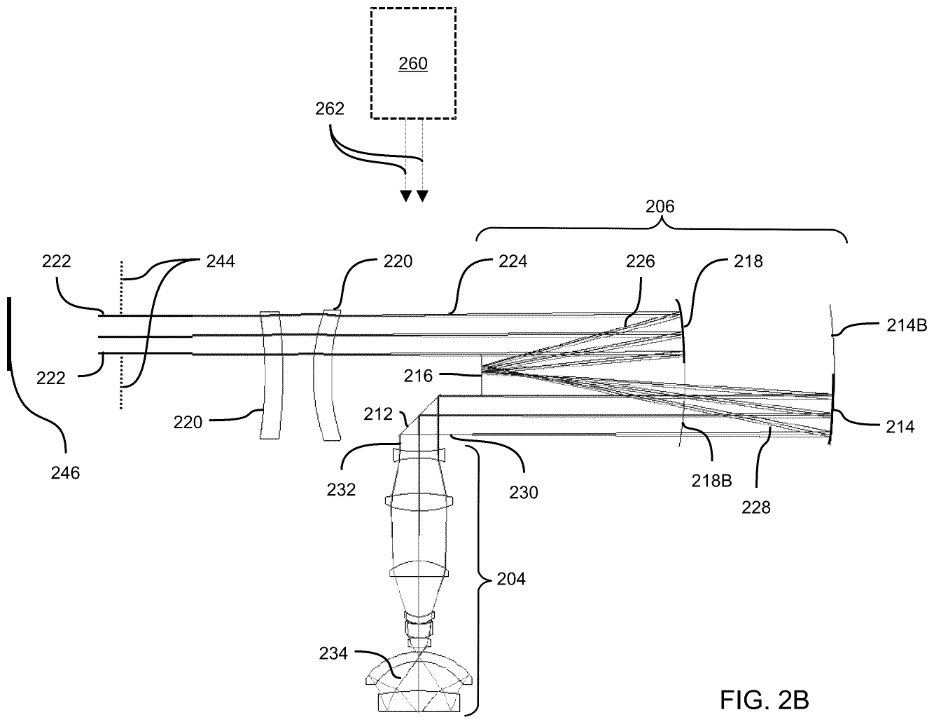

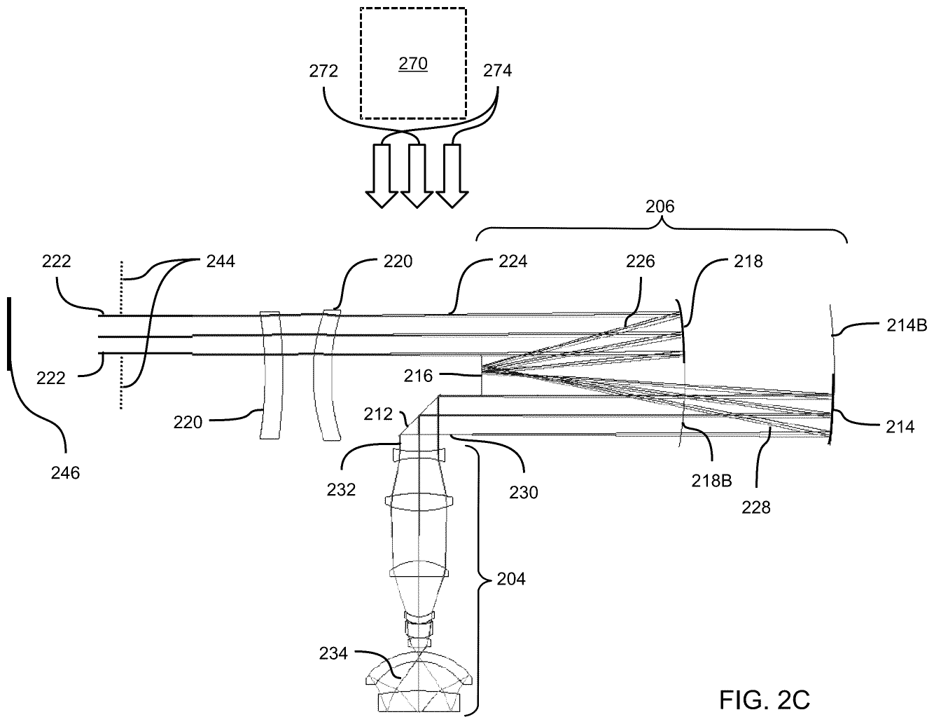

For purposes of better understanding some embodiments of the present disclosure, as illustrated in FIGS. 2A-2C, 3 and 4 of the drawings, reference is first made to the construction and operation of components and optical paths in a prior art optical inspection system as illustrated in FIG. 1, which is a simplified illustration of components and optical paths in a prior art optical inspection system.

FIG. 1 shows a cross sectional view of components and optical paths of a prior art optical inspection system which includes an objective component 104, a refractive relay component 108, a mirror 112, an optical focusing component 116 and an imaging component 118.

FIG. 1 demonstrates an optical light path through the components of the optical inspection system of FIG. 1. FIG. 1 shows illumination 120, which passes around the mirror 112, through lenses 110 of the refractive relay component 108, through the objective component 104, and onto an object under inspection 102, which may be, by way of some non-limiting examples, a mask 102 or a wafer 102. Light reflected from the object under inspection 102 is collected by the objective component 104, transmitted through the refractive relay component 108, onto the mirror 112. The mirror changes the direction of the optical axis of the light path perpendicularly sideways. Light from the mirror 112 passes through a focusing optical component 116 and onto the imaging component 118.

It is noted that an exit pupil of the light reflected from the object under inspection 102 through the objective 104 is imaged at a pupil 114, such that a correspondence 140 exists between the exit pupil of the light reflected from the object under inspection 102 through the objective component 104 and the pupil 114.

Light reflected and/or scattered from various gas-to-glass interfaces in the optical inspection system of FIG. 1 is now described.

A first instance of reflected and/or scattered light 132 shows reflection and/or scattering of illumination light from a gas-to-glass interface of a lens surface in the objective component 104. The reflected and/or scattered light 132 enters the relay component 108, and at least some of the reflected and/or scattered light 132 may end up reaching the imaging component 118 and degrading an image of the object under inspection 102. The relay component 108 is close by the source of the reflected and/or scattered light 132, and potentially collects a large portion of the reflected and/or scattered light 132, since entrance to the relay component 108 takes up a large portion of the spatial angle seen by the gas-to-glass interface of the lens surface in the objective component 104.

A second instance of reflected and/or scattered light 134 shows reflection and/or scattering of illumination light from a gas-to-glass interface of a lens surface in the refractive relay component 108. At least some of the reflected and/or scattered light 134 reaches the mirror 112, enters the focusing optical component 116, reaches the imaging component 118, and degrades the image of the object under inspection 102. The relay component 108 is close by the mirror 112, and potentially collects a large portion of the reflected and/or scattered light 134.

A third instance of reflected and/or scattered light 136 shows reflection and/or scattering of light from a glass-to-gas interface of a lens surface in the focusing component 116. At least some of the reflected and/or scattered light 136 reaches the imaging component 118 and degrades quality of an image of an object under inspection 102.

### OVERVIEW

In an optical inspection system, replacing a prior art refractive relay component with a reflective relay component potentially provides one or more of the benefits listed below. Optionally placing the relay component off the optical axis of the objective component may also provide one or more of the benefits listed below.

### Potential Benefits:

### Reduction of Unwanted Light Reflectance

In a reflective relay component, there are less air-to-glass or glass-to-air interfaces. A lens in a refractive relay component provides two such interfaces, each one of which potentially reflects a certain small percentage of light passing through, while a mirror in a reflective relay component provides just one surface and no unwanted reflection.

A relay component off the optical axis of the of the objective component can potentially reduce capture by the relay component of unwanted light reflectance and/or unwanted stray light.

It is noted that in a case of dark-field operation, an inspection image is mostly dark, and in such a case having unwanted light reflectance can produce significant, more-visible, noise in the image, and reduce the signal-to-noise of the inspected image even more than in a case of bright-field inspection.

It is noted that switching between bright-field inspection and dark-field inspection can be done before illumination light enters an objective, or before illumination light enters through a relay system and through the objective. When bright-field illumination is desired, an illumination beam is produced, whose cross section, perpendicular to the illumination axis, is a circle, with illumination across the circle including the center of the circle. When dark-field illumination is desired, an illumination beam is produced, whose cross section, perpendicular to the illumination axis is a ring, and a center of the ring is not illuminated.

### Catadioptric Configuration

In some embodiments the relay component is designed to use three mirrors in a catadioptric configuration.

In some embodiments the relay component is designed to use just two mirrors in a catadioptric configuration.

### Simplified Configuration of Autofocus Coupling to an Inspection System

In some embodiments, an autofocus system is coupled to an inspection system which uses a relay component as described herein.

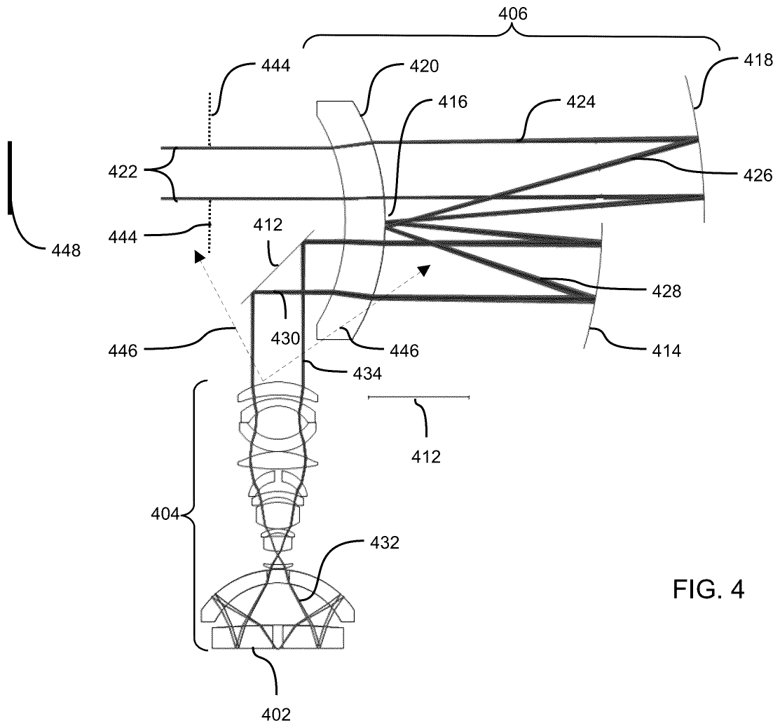

In some embodiments, the autofocus system is coupled to the inspection system by an optical element (see, by way of a non-limiting example reference 212 in FIG. 2A, or reference 412 in FIG. 4) having a dichroic coating, such that light to and from the autofocus system passes through the optical element, while light to and from the relay component is reflected by the optical element.

A coupling of the autofocus system to the inspection system as described above and later with reference to FIGS. 2 and 4 potentially provides a benefit by simplifying a design of the inspection system.

### Large FOV

A catadioptric optical design, or a catadioptric-like optical design, can provide a larger Field-Of-View (FOV) than a refractive optical design of similar diameter and/or length of focus.

In some embodiments, the relay component described herein is designed with a large FOV.

### Large Numerical Aperture (NA)

A catadioptric optical design, or a catadioptric-like optical design, can provide a larger numerical aperture (NA) than a refractive optical design of similar diameter and/or length of focus.

In some embodiments, the relay component described herein is designed with a large NA.

### Reduction of Unwanted Light Absorption

In a reflective relay component there are less, or no, instances of light passing through glass, while in a refractive relay component light passes through lenses. A small amount of light may be absorbed by the lenses. The more power passes through the lenses, the more the lenses may heat up and warp, potentially decreasing accuracy of the optical inspection. A reflective surface or mirror absorbs little or no power. A benefit of increasing illumination light power is that a contrast of an inspected image is increased, and/or speed of imaging and advancing across an inspected object can be increased by using higher power of illumination. The above-described reduction of unwanted light absorption enables optionally illuminating an object under inspection with greater illumination power, thereby potentially enabling faster image acquisition, and potentially enabling faster throughput of the inspection, for example covering a greater area in less time.

Reference is now made to FIG. 2A, which is a simplified illustration of components and optical paths in an example embodiment.

FIG. 2A shows a cross sectional view of components and optical paths of an optical inspection system which includes an objective component 204, a mirror 212, and a reflective relay component 206.

FIG. 2A also demonstrates an optical light path through the components of the optical inspection system of FIG. 2A.

FIG. 2A shows collected light 234 collected from an object under inspection, such as a wafer or a mask, which exits the objective component 204 as light 232.

The light 232 is reflected by a first mirror 212, continues as light 230, and enters the reflective relay component 206.

In the relay component 206, the light 230 is reflected by a second mirror 214, continuing as light 228, is reflected by a third mirror 216, continuing as light 226, is reflected by a fourth mirror 218, and exits the reflective relay component 206 and continues as light 224.

In some embodiments the light 224 may pass through one or more optional focusing component(s) 220, emerging as light 222, eventually impinging upon an imaging array 246, or a detector 246, or a sensor 246.

In some embodiments illumination light for illuminating the object under inspection passes in reverse order back along some, most, or all of the above-described optical path.

It is also noted that in some embodiments the first mirror 212 may optionally serve to admit light 252 from an optional illumination system as described in FIG. 2B, and/or from an optional autofocus system 270 as described in FIG. 2C.

It is noted that an exit pupil 244 of the light reflected from the object under inspection through the reflective relay component 206 may optionally be located far from the objective component 204, in comparison to the distance (shown in FIG. 1) between the exit pupil of the light reflected from the object under inspection 102 through the objective component 104 and the pupil 114.

It is noted that using reflective components in the relay component 206 reduces a number of glass-to-air and air-to glass interfaces in the relay component 206, which are potential locations for reflecting and/or scattering light which may potentially degrade images taken through the components of the example embodiment displayed in FIG. 2A.

It is noted that the optical design of the relay component 206 is similar to a design of a catadioptric telescope.

It is noted that placing the relay component 206 off the optical axis of the objective component 204 may reduce reception of unwanted stray light from the objective component 204.

In some embodiments, the fourth mirror 218 and the second mirror 214 may be at a same distance from the third mirror 216 (such is not shown in FIG. 2A).

In some embodiments, the fourth mirror 218 and the second mirror 214 may be portions of the same mirror (such is not shown in FIG. 2A).

In some embodiments, the fourth mirror 218 may optionally extend 218B as shown in FIG. 2, where the extension 218B may optionally be transparent.

In some embodiments, the second mirror 214 may optionally extend 214B as shown in FIG. 2A.

It is noted that a refractive relay component such as the refractive relay component 108 shown in FIG. 1 includes many more glass-to-air and air-to-glass interfaces, which produce unwanted reflections, than a reflective relay component 206 as shown in FIG. 2A. The reflective relay component 206 produces zero, or at least much less, such unwanted reflections.

It is noted that the reflective relay component as shown in FIG. 2A and other drawings showing example embodiments distances the exit pupil 244 of the relay component from the lenses of the objective component, thereby reducing light passed through the reflective relay component 206 produced by reflections from the glass-to-air and air-to-glass interfaces in the objective component.

It is noted that an imaging component 246 is typically used in the optical inspection system shown in FIG. 2A.

Reference is now made to FIG. 2B, which is a simplified illustration of components and optical paths in an example embodiment.

FIG. 2B shows the components and optical path(s) shown in FIG. 2A, referenced by the same reference numbers, plus additional optional autofocus component(s) 260.

In some embodiments the first mirror 212 serves to admit light 262 through for an optional autofocus system 260.

In some embodiments the first mirror 212 may optionally be coated with a dichroic coating, so that the light 262 passes through the first mirror 212, by virtue of the dichroic coating being selected to pass that wavelength through, while the light to the reflective relay component 206 is reflected by the first mirror 212 by virtue of the dichroic coating being selected to reflect at a wavelength of the light used for inspection.

Reference is now made to FIG. 2C, which is a simplified illustration of components and optical paths in an example embodiment.

FIG. 2C shows the components and optical path(s) shown in FIG. 2A, referenced by the same reference numbers, plus additional illumination component(s) 270.

In some embodiments the first mirror 212 serves to admit light through for an optional illumination system 270.

The optional illumination system 270 may optionally provide illumination 272 to impinge upon the first mirror 212, to pass through the first mirror 212 and through the objective component 204, to illuminate an object under inspection, for example a wafer or a mask.

In some embodiments the optional illumination system 270 may optionally provide annular illumination 274, which passes around the mirror 212, through the objective component 204, through the objective component 104, and onto the object under inspection. Such an illumination scheme can provide illumination for using a dark-field based technique.

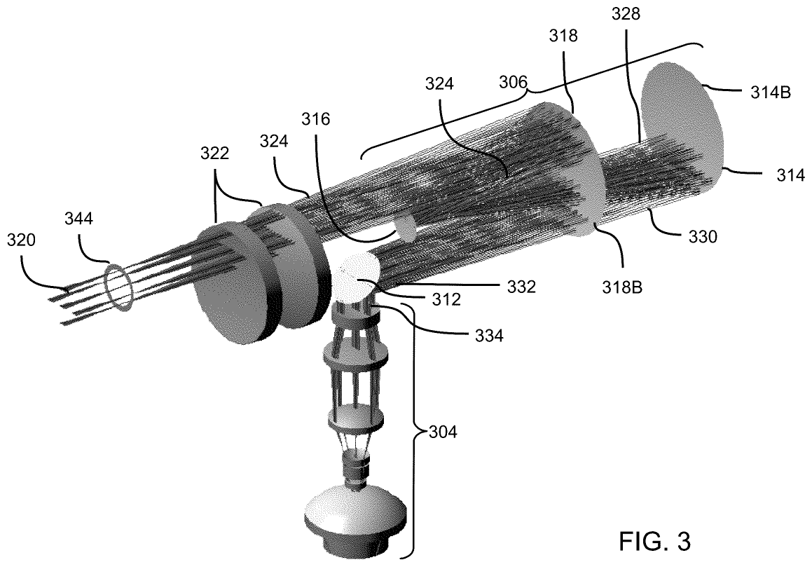

Reference is now made to FIG. 3, which is a simplified isometric illustration of components and optical paths in the example embodiment of FIG. 2A.

FIG. 3 shows an isometric view of components and optical paths of an optical inspection system which includes an objective component 304, a mirror 312, and a reflective relay component 306.

FIG. 3 demonstrates an optical light path through the components of the optical inspection system of FIG. 3.

FIG. 3 shows collected light 334 collected from an object under inspection, such as a wafer or a mask, which exits the objective component 304.

The light 334 is reflected by a first mirror 312, continues as light 332, and enters the reflective relay component 306 as light 330.

In the relay component 306, the light 330 is reflected by a second mirror 314, continuing as light 328, is reflected by a third mirror 316, continuing as light 324, is reflected by a fourth mirror 318, and exits the reflective relay component 306 and continues as light 324.

In some embodiments the light 324 may optionally pass through one or more optional focusing component(s) 322, emerging as light 320, eventually impinging upon an imaging array (not shown), or a detector (not shown), or a sensor (not shown).

In some embodiments illumination light for illuminating the object under inspection passes in reverse order back along some, most, or all of the above-described optical path.

FIG. 3 shows light passing through the components of the optical inspection system.

It is noted that an exit pupil 344 of the light reflected from the object under inspection through the reflective relay component 306 may optionally be located far from the objective component 304, in comparison to the distance (shown in FIG. 1) between the exit pupil of the light reflected from the object under inspection 102 through the objective component 104 and the pupil 114.

Reference is now made to FIG. 4, which is a simplified illustration of components and optical paths in an example embodiment.

FIG. 4 shows a cross sectional view of components and optical paths of an optical inspection system which includes an objective component 404, a mirror 412, and a reflective relay component 406.

FIG. 4 also demonstrates an optical light path through the components of the optical inspection system of FIG. 4.

FIG. 4 shows light 432, collected by the objective component 404 from an object under inspection, which may be, by way of some non-limiting examples, a mask or a wafer. The light 432 exits the objective component 404 as light 434 and is reflected as light 430 from a first mirror 412, which directs the light 430 into the reflective relay component 406.

The light 430 enters the reflective relay component 406, passes through a refractive element 420, gets reflected as light 428 from a second mirror 414, gets reflected from a third mirror 420 as light 426, gets reflected from a fourth mirror 418 as light 424, and passes through the refractive element 420 as light 422.

In some embodiments, illumination light for illuminating the object under inspection may pass in reverse order back along the above-described optical path.

In some embodiments the first mirror 412 serves to admit light from an autofocus system (not shown in FIG. 4), similar to the first mirror 212 described with reference to FIG. 2A. The first mirror 412 may optionally be coated with a dichroic coating, so that illumination light from the autofocus system passes through the first mirror 412, by virtue of the dichroic coating being selected to pass that wavelength through, while the light of the reflective relay component 406 is reflected by the first mirror 412 by virtue of the dichroic coating being selected to reflect at a wavelength of the light passing through the reflective relay component 406.

It is noted that an exit pupil 444 of the light reflected from the object under inspection through the reflective relay component 406 may optionally be located far along the optical path from the objective component 404, in comparison to the distance (shown in FIG. 1) between the exit pupil of the light reflected from the object under inspection 102 through the objective component 104 and the pupil 114.

It is noted that using reflective components in the relay component 406 reduces a number of glass-to-air and air-to glass interfaces in the relay component 406, which are potential locations for reflecting and/or scattering light which may potentially degrade images taken through the components of the example embodiment displayed in FIG. 4.

It is noted that the optical design of the relay component 406 is similar to a design of a catadioptric telescope.

In some embodiments, the fourth mirror 418 and the second mirror 414 may be at a same distance from the third mirror 416 (such is not shown in FIG. 4).

In some embodiments, the fourth mirror 418 and the second mirror 414 may be portions of the same mirror (such is not shown in FIG. 4).

It is noted that a refractive relay component such as the refractive relay component 108 shown in FIG. 1 includes many more glass-to-air and air-to-glass interfaces, which produce unwanted reflections, than a reflective relay component 406 as shown in FIG. 4 and other drawings showing example embodiments. The reflective relay component 408 produces much less such unwanted reflections.

It is noted that the reflective relay component as shown in FIG. 4 and other drawings showing example embodiments distances the exit pupil 444 of the relay component from the lenses of the objective component, thereby reducing light passed through the reflective relay component 408 produced by reflections from the glass-to-air and air-to-glass interfaces in the objective component.

It is noted that an imaging component 448 is typically used in the optical inspection system shown in FIG. 4, similarly to the imaging component 246 shown in FIG. 2A.

An instance of reflected and/or scattered light 446 shows reflection and/or scattering of illumination light from a gas-to-glass interface of a lens surface in the objective component 404. The reflected and/or scattered light 446 enters the relay component 406, and at least some of the reflected and/or scattered light 446 may end up reaching an imaging component (not shown) and degrading an image of an object under inspection. However, in comparison to the reflected and/or scattered light shown in FIG. 1, the relay component 406 is not as close to the source of the reflected and/or scattered light 446 and collects a smaller portion of the reflected and/or scattered light 446 relative to the portion collected by the configuration shown in FIG. 1.

### SUMMARY OF THE PRESENT DISCLOSURE

### Example 1

An optical inspection system for inspection of a mask or a wafer, the system including an objective for collecting light coming from an object being inspected, a relay component placed on an optical path between the objective and an imaging component, for collecting light from the objective, and relaying the collected light to the imaging component, wherein the optical inspection system further includes a mirror placed on the optical path between the objective and the relay module, for changing a direction of the optical path at an angle away from an optical axis of the objective and into an optical axis of the relay component, the relay component includes a first optical element along the optical axis of the relay component is a reflective surface, a second optical element along the optical axis of the relay component is a reflective surface for receiving light reflected from the first optical element, and a third optical element along the optical axis of the relay component is a reflective surface for receiving light reflected from the second optical element, such that the collection light passes back and forth within the relay component three times.

### Example 2

The optical inspection system according to example 1 wherein the relay component includes two or more mirrors in a catadioptric configuration.

### Example 3

The optical inspection system according to any one of examples 1-2 wherein the relay component includes three mirrors in a catadioptric configuration.

### Example 4

The optical inspection system according to any one of examples 1-3 wherein the optical inspection system is configured to provide illumination light for illuminating the object being inspected through the relay component, on the optic path of collecting light from the objective, in an opposite direction.

### Example 5

The optical inspection system according to any one of examples 1-4 configured to transfer from light-field operation to dark-field operation.

### Example 6

The optical system according to any one of examples 1-5 wherein the angle is in a range between 75 and 105 degrees.

### Example 7

The optical inspection system according to any one of examples 1-6 wherein the first optical element in the relay component in the direction along the optic path of collecting light is configured for receiving light on substantially one-half of an area of the first optical element, and the third optical element in the relay component in the direction along the optic path of collecting light is configured for receiving light on substantially one-half of an area of the third optical element.

### Example 8

The optical inspection system according to any one of examples 1-7 wherein the relay module images an exit pupil of the objective outside the relay module.

### Example 9

A method for improving signal-to-noise in an image produced by an optical mask or wafer inspection system, the system including an objective for collecting light coming from the object being inspected, a relay component for relaying the collected light, a mirror placed on the optical path between the objective and the relay module, for changing a direction of the optical path at an angle away from an optical axis of the objective and into the optical axis of the relay component, and an imaging component for receiving the collected light from the relay module and producing an image from the collected light, the method including reducing a number of gas-to-glass interfaces in the relay component by using at least one mirror in the relay component.

### Example 10

The method according to example 9, including reducing a number of gas-to-glass interfaces in the relay component by using at least two mirrors in the relay component.

### Example 11

The method according to example 9, including reducing a number of gas-to-glass interfaces in the relay component by using at least three reflective surfaces.

### Example 12

The method according to any one of examples 9-11, including using a catadioptric design for the relay component.

### Example 13

An optical inspection system for inspection of a mask or a wafer, the system including an objective for illuminating an object being inspected and collecting light coming from the object being inspected, a relay component placed on an optical path between the objective and an imaging component, for relaying illumination light to the objective, collecting light from the objective, and relaying the collected light to the imaging component, wherein the optical inspection system further includes a mirror placed on the optical path between the objective and the relay module, for changing a direction of the optical path at an angle away from an optical axis of the objective and into an optical axis of the relay component, the relay component includes a first optical element along the optical axis of the relay component is a refractive element, a second optical element along the optical axis of the relay component is a reflective surface, a third optical element along the optical axis of the relay component is a reflective surface deposited on a surface of the first optical element, a fourth optical element along the optical axis of the relay component is a reflective surface, a fifth optical element along the optical axis of the relay component is the first optical element, such that the collected light passes back and forth within the relay component three times, and the relay module images an exit pupil of the objective outside the relay component.

### Example 14

The optical inspection system according to example 13 wherein the second optical element and the fourth optical element are reflective surfaces on one mirror.

As such, those skilled in the art to which the present invention pertains, can appreciate that while the present invention has been described in terms of preferred examples, the concept upon which this disclosure is based may readily be utilized as a basis for the designing of other structures, systems and processes for carrying out the several purposes of the present invention.

The various illustrative logical blocks, modules, and algorithm steps described in connection with the examples disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing any departure from the scope of the disclosure.

It will also be understood that the system according to the present disclosure may be, at least partly, implemented on a suitably programmed computer. Likewise, the present disclosure contemplates a computer program being readable by a computer for executing the method of the invention. The present disclosure further contemplates a non-transitory computer-readable memory tangibly embodying a program of instructions executable by the computer for executing the method of the present disclosure.

Also, it is to be understood that the phraseology and terminology employed herein are for the purpose of description and should not be regarded as limiting.

It should be noted that the words “comprising”, “including” and “having” as used throughout the appended claims are to be interpreted to mean “including but not limited to”. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases, and disjunctively present in other cases.

It is important, therefore, that the scope of the invention is not construed as being limited by the illustrative examples set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

As used herein with reference to quantity or value, the term “about” means “within ±25% of”.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The word “example” is used herein to mean “serving as an example, instance or illustration”. Any embodiment described as an example is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Unless otherwise indicated, numbers used herein and any number ranges based thereon are approximations within the accuracy of reasonable measurement and rounding errors as understood by persons skilled in the art.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. An optical inspection system for inspection of a mask or a wafer, the system comprising:
an objective for collecting light coming from an object being inspected;
a relay component placed on an optical path between the objective and an imaging component, for collecting light from the objective, and relaying the collected light to the imaging component;
wherein:
the optical inspection system further comprises a mirror (212) placed on the optical path between the objective and the relay module, for changing a direction of the optical path at an angle away from an optical axis of the objective and into an optical axis of the relay component;
the relay component comprises:
a first optical element along the optical axis of the relay component is a reflective surface (214);
a second optical element along the optical axis of the relay component is a reflective surface (216) for receiving light reflected from the first optical element; and
a third optical element along the optical axis of the relay component is a reflective surface (218) for receiving light reflected from the second optical element,
such that the collection light passes back and forth within the relay component three times.

2. The optical inspection system according to claim 1 wherein the relay component comprises two or more mirrors in a catadioptric configuration.

3. The optical inspection system according to claim 1 wherein the relay component comprises three mirrors in a catadioptric configuration.

4. The optical inspection system according to claim 1 wherein the optical inspection system is configured to provide illumination light for illuminating the object being inspected through the relay component, on the optic path of collecting light from the objective, in an opposite direction.

5. The optical inspection system according to claim 1 configured to transfer from light-field operation to dark-field operation.

6. The optical system according to claim 1 wherein the angle is in a range between 75 and 105 degrees.

7. The optical inspection system according to claim 1 wherein:
the first optical element (214) in the relay component in the direction along the optic path of collecting light is configured for receiving light on substantially one-half of an area of the first optical element; and
the third optical element (218) in the relay component in the direction along the optic path of collecting light is configured for receiving light on substantially one-half of an area of the third optical element.

8. The optical inspection system according to claim 1 wherein the relay module images an exit pupil of the objective outside the relay module.

9. A method for improving signal-to-noise in an image produced by an optical mask or wafer inspection system,
the system comprising:
an objective for collecting light coming from the object being inspected;
a relay component for relaying the collected light;
a mirror placed on the optical path between the objective and the relay module, for changing a direction of the optical path at an angle away from an optical axis of the objective and into the optical axis of the relay component; and
an imaging component for receiving the collected light from the relay module and producing an image from the collected light,
the method comprising reducing a number of gas-to-glass interfaces in the relay component by using at least one mirror in the relay component.

10. The method according to claim 9, comprising reducing a number of gas-to-glass interfaces in the relay component by using at least two mirrors in the relay component.

11. The method according to claim 9, comprising reducing a number of gas-to-glass interfaces in the relay component by using at least three reflective surfaces.

12. The method according to claim 9, comprising using a catadioptric design for the relay component.

13. An optical inspection system for inspection of a mask or a wafer, the system comprising:
an objective for illuminating an object being inspected and collecting light coming from the object being inspected;
a relay component placed on an optical path between the objective and an imaging component, for relaying illumination light to the objective, collecting light from the objective, and relaying the collected light to the imaging component;
wherein:
the optical inspection system further comprises a mirror placed on the optical path between the objective and the relay module, for changing a direction of the optical path at an angle away from an optical axis of the objective and into an optical axis of the relay component;
the relay component comprises:
a first optical element along the optical axis of the relay component is a refractive element (420);
a second optical element along the optical axis of the relay component is a reflective surface (414);
a third optical element along the optical axis of the relay component is a reflective surface (416) deposited on a surface of the first optical element;
a fourth optical element along the optical axis of the relay component is a reflective surface (418);
a fifth optical element along the optical axis of the relay component is the first optical element (420);
such that the collected light passes back and forth within the relay component three times; and
the relay module images an exit pupil of the objective outside the relay component.

14. The optical inspection system according to claim 13 wherein the second optical element and the fourth optical element are reflective surfaces on one mirror.
